(19) United States
(12) Patent Application Publication
(10) Pub. No.: US 2026/0039605 A1
(43) Pub. Date: Feb. 5, 2026

(54) Duplicate Packet Elimination for Resilient Communication

(71) Applicant: Siemens Canada Limited, Oakville (CA)

(72) Inventors: Mirjana Zafirovic-Vukotic, Maple (CA); Jürgen Schmitt, Fürth (DE); Johannes Riedl, Landshut (DE); Amir Varastehhajipour, München (DE)

(73) Assignee: Siemens Canada Limited, Oakville (CA)

(21) Appl. No.: 18/791,954

(22) Filed: Aug. 1, 2024

(51) Int. Cl. H04L 47/32; H04L 47/2483; H04L 47/34

(52) U.S. Cl. CPC H04L 47/32; H04L 47/2483; H04L 47/34

(57) ABSTRACT

Systems, methods, and media for a packet elimination system for resilience is disclosed. Duplicate member flows are established and include first and second flows. A drop count of the duplicate member flows is set to null. A packet is detected at a packet elimination module. The packet is passed through to a destination end device and the drop count is set to null in response to determining that the packet is associated with the first flow. The packet is dropped and the drop count is incremented subsequent to determining that the packet is not associated with the first flow. The second flow is designated as the first flow, the first flow is reassigned, and the drop count is set to null in response to determining that the drop count is greater than a threshold drop count.

### TECHNICAL FIELD

This application relates to the field of data packet communication networks having duplicate packet elimination capabilities and, more particularly, to systems for resilience performance of duplicate packet elimination functions.

### BACKGROUND

For packet data networks, duplicate packets may be sent through different paths through a communication network and experience different transfer delays. Conventional duplicate packet elimination systems use packet sequence numbers or packet elimination based on receiving only one configured member flow. These conventional systems may experience technical issues due to the fact that they do not take into consideration situations where duplicate packets may experience substantial delays. Resilience performance and functional requirements, or specific methods and algorithms thereof, are not well defined by a standards body or similar organization.

The existing duplicate packet elimination methods are not designed for resilience but, instead, are designed for reliability or statically configured to receive one member flow. Examples are IEEE Std 802.ICB-2017 Frame Replication and Elimination for Reliability (FRER), packet elimination as per IEC 62439-3 2021 for PRP and HSR (Parallel Redundancy Protocol and High availability Seamless Redundancy), frame elimination explanations related to 5G in 3GPP TS 29.244 V18.6.0 (2024-06), frame elimination discussion for multicast architecture in IETF draft-xiong-bier-resilience-02.txt, and DetNet Packet Replication, Elimination, and Ordering functions (PREOF) explained in IETF RFC 8655, RFC 8938 and RFC 9566. Some dual homed IEC 61850 end devices that receive two member flows are statically preconfigured, so that the packet elimination module passes only one member flow, and the other member flow is not used. No duplicate elimination algorithm is specified in IEC 61850, nor available in the public domain.

Generally, the delays of duplicate packets may be significantly different. For example, this is the case with the use of diverse types of networks like terrestrial packet switched internet protocol (IP) networks, non-terrestrial networks (NTNs), all optical circuit switched networks, etc. It is also the case when crossing huge distances for whatever reason e.g., when communicating with the other side of Earth.

The two duplicate packets may arrive at the elimination module with a significant time difference, even though they started approximately at the same time at the duplication module. The difference between the delays from the duplication to the elimination module for the duplicate packets is called the differential delay in RFC 8938. It is acknowledged in RFC 8938 that a large differential delay may happen and that it may be prohibitive for the packet elimination and reordering function.

The existing duplicate packet elimination methods eliminate the duplicate at the elimination module and deliver a packet that arrived on either flow. Of course, no packet is delivered if neither duplicate packet arrived at the elimination module. In some cases, the existing duplicate packet elimination algorithms may keep a record of the sequence numbers of the received packets to determine if the newly received packet is a duplicate and needs to be dropped or such packet has not been received yet and needs to be delivered.

After the duplicate elimination, packets are generally delivered out of order i.e., the order of their delivery is not the same as the order of their transmission at the duplication module. A packet reordering function, see e.g. RFC 9550 for an example of packet ordering function, normally follows the duplicate elimination, see again e.g. RFC 9550. It reorders the packets and delivers them further. The packet reordering function requires that all packets, that the reordering function received and have not yet delivered further, are stored. This requires buffering and processing resources. The larger the difference between the delays from the duplication to the elimination module for the duplicate packets, the more resources required. The required resources may be prohibitive for such packet elimination and, also, the required resources may be prohibitive for the reordering function.

### SUMMARY

In accordance with one embodiment of the disclosure, there is provided a resilient approach for duplicate packet elimination of a data packet network. The approach delivers systems and methods for duplicate packet elimination that perform well independent of the delay, packet loss rate and of other QoS that the duplicate packets experience. The systems and methods facilitate resilient communication, e.g., resilient control application communication, and may be applied within any layer in the communications. Aspects include no requirement of usage of packet sequence numbers and the usage of packets from multiple member flows.

One aspect is a packet elimination system for resilience comprising duplicate member flows and a packet elimination module. The duplicate member flows include a first flow and a second flow, and the duplicate member flows also include a drop count set to a null value initially within the packet elimination module. A packet is detected at a packet elimination module of the packet elimination system. The packet elimination module passes through the packet to a destination end device and sets the drop count in response to determining that the packet is associated with the first flow. The packet elimination module drops the packet and increments the drop count subsequent to determining that the packet is not associated with the first flow. The packet elimination module designates the second flow as the first flow, reassigns the first flow, and sets the drop count to the null value in response to determining that the drop count is greater than a threshold drop count.

Another aspect is a method of a packet elimination system for resilience. Duplicate member flows are established, and the duplicate member flows include a first flow and a second flow. A drop count of the duplicate member flows is set to a null value initially within the packet elimination module. A packet is detected at a packet elimination module of the packet elimination system. The packet is passed through to a destination end device and the drop count is set to the null value in response to determining that the packet is associated with the first flow. The packet is dropped and the drop count is incremented subsequent to determining that the packet is not associated with the first flow. The second flow is designated as the first flow, the first flow is reassigned, and the drop count is set to the null value in response to determining that the drop count is greater than a threshold drop count.

Yet another aspect is a non-transitory computer readable medium including executable instructions which, when executed, causes at least one processor to provide resilience for a packet elimination system by the above method.

The above described features and advantages, as well as others, will become more readily apparent to those of ordinary skill in the art by reference to the following detailed description and accompanying drawings. While it would be desirable to provide one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects.

FIG. 1 is a system diagram in example implementations that are operable to employ techniques described herein.

FIG. 2 is a system diagrams in another example implementations that are operable to employ techniques described herein.

FIG. 3 is a system diagram of still another example implementation that is operable to employ the techniques described herein.

FIG. 4 is a block diagram of an example implementation of the packet elimination module of FIGS. 1, 2, and 3.

FIG. 5 depicts an example encapsulation for duplicate packets of the duplicate flows of FIGS. 1, 2, and 3.

FIG. 6 is a flow diagram representing an example implementation of an operation of the packet elimination module of FIGS. 1, 2, and 3.

FIG. 7 is a flow diagram representing another example implementation of an operation of the packet elimination module of FIGS. 1, 2, and 3.

FIG. 8 is a flow diagram representing yet another example implementation of an operation of the packet elimination module of FIGS. 1, 2, and 3.

### DETAILED DESCRIPTION

Various technologies that pertain to systems and methods that facilitate the resilient systems and methods for duplicate packet elimination of a data packet network will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements.

Similarly, for instance, an element may be configured to perform functionality that is described as being carried out by multiple elements. The numerous innovative teachings of the present application will be described with reference to exemplary non-limiting embodiments.

Resilience is the capability to perform after severe failures of more than one element in a communication network. Such severe failures may be due to any cause whether natural or human induced. Examples of natural causes include earthquakes, wildfires, hurricanes, tsunamis, volcanic eruptions, meteor impact, etc. Examples of human-induced causes include warfare, malfunctioning software, cyberattack, etc. Generally, after such severe failures, possible results include only some parts of the network may become operational, some services may not be possible, the previous QoS may not be reached, and the like. Also, network operation after such severe failures may not be established until after a significant delay. The delay may be much greater than any failover or recovery delays for a single component failure, e.g., 50 ms for IEC 61850.

The resilient approach ensures that one or more duplicates are eliminated without attempting to deliver the duplicates of lost packets, i.e., packets that do not arrive at the elimination module. In case of a major failure in the network that affects one of the member flows, the communication continues with no need of reconfiguration, allowing for some packet loss since this approach for duplicate packet elimination is directed primarily to resilience. Accordingly, the resilience of packet delivery is maximized. In addition, in contrast to conventional approaches, the need for additional buffer space or processing power is minimized for situations when communication delays of duplicate data packets between the packet duplication and packet elimination modules are significantly different.

The importance of resilience may be illustrated by example. In the case of a major disaster, a part of an electric power grid may be destroyed as well as its associated communication network infrastructure. More than one element in the control communication network may be subjected to a severe failure, thus leading to the loss of power within a large area. It is important to restore as much power as possible to the remaining infrastructure within a reasonably short period of time. The communication network needs to be resilient so that devices and their control applications may function well enough, and have sufficient time, to allow the power grid to return online.

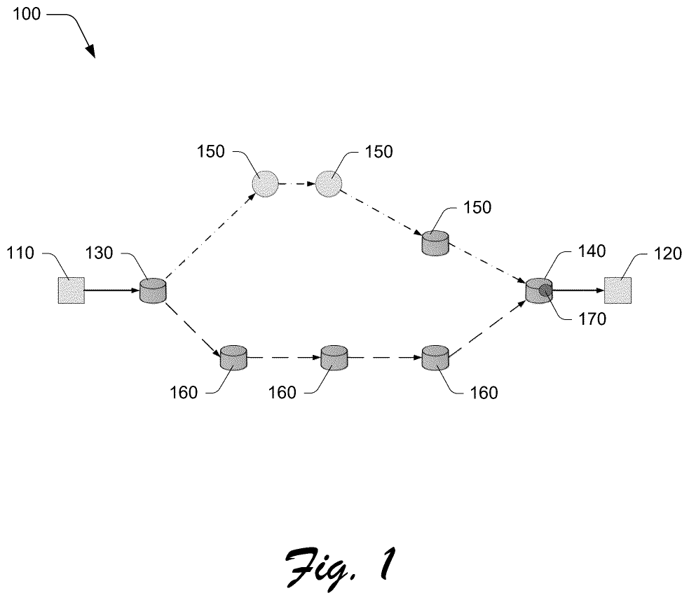

Referring to FIG. 1, there is shown a first system 100 operable, by example, to employ techniques described herein. Communications between end devices, including a source end device 110 and a destination end device 120, occurs via multiple paths for redundancy and resilience. The source end device 110 forms multiple member flows (also referred to as duplicate flows) from a single compound flow. Each end device 110, 120 includes a control application, and the control application of the source end device 110 adds control data to data packets directed to the destination end devices 120.

The systems and methods described herein require a control application that requires communications with high resilience. Control applications requiring duplicate packet elimination systems may be used for power, transportation, resource supply, healthcare systems. Examples include electric power grid protection and control application and its communication IEC 61850, control of railway trackside interlocking, water supply control system, robot control for remote surgery, and the like. Such systems may experience significant differences in transfer delays of multiple data packets.

The control applications may also apply to communications for terrestrial networks and non-terrestrial networks (“NTN”). One packet may be sent via a terrestrial path while a copy may be sent via a non-terrestrial path. Data may be transferred between terrestrial stations through one or more nodes of an NTN. Each terrestrial station may be located on the ground, an aircraft, a train, or other locations that benefit from communications with an orbital satellite. Examples of NTN are satellite networks based on Low Earth Orbit (LEO), Medium Earth Orbit (MEO), Geostationary Earth Orbit (GEO), Very Low Earth Orbit (VLEO), Unmanned Aerial System (UAS) and other satellites, including the use of drones or similar objects in atmosphere. The NTN packet transfer delays are significantly different from the delays in terrestrial networks due to the signal propagation delay over significantly different distances.

The control applications may also apply to optical switching networks in which one packet may be sent via a usual packet switching network while a copy may be sent via a path than includes, in part or in entirety, an optical switching telecom network. An example of optical switching telecom network includes a Fifth generation fixed (F5G) optical transport network that uses wave division multiplexing (WDM) and/or time division multiplexing (TDM) to provide services with small end to end delays (e.g., ETSI GS F5G 014 V1.1.1 (2023-05)). Duplicate packets of these various applications may experience significantly different transfer delays.

Referring still to FIG. 1, for some embodiments, each packet of the communication is duplicated at a duplication module 130. The duplication module 130 forms duplicate packets to be carried by the duplicate flows from an original packet of the compound flow received from the source end device 110. For such embodiments, an elimination module 140 at the receiving end of the duplicate flows eliminates any duplicate packets so that only at most one such copy is delivered to the destination end device 120. Although two member flows are illustrated by FIG. 1, it is to be understood that the system may apply to multiple member flows, i.e., more than two member flows. The locations of the duplication module 130 and the elimination module 140 may differ based on different methods of deployment. For example, the modules may be located in a router or a switch. Member flows may take disjoint paths through the communication networks, although not required for the system. Disjoint paths may be established in different ways, such as by multiprotocol label switching-traffic engineering (MPLS-TE).

The first system 100 includes one or more interim devices 150, 160 along each of the multiple member flows. The interim devices 150, 160 form part of networks for various communication systems, such as electric power grid protection, control applications (transportation systems, water supply systems, robotic systems, etc.), terrestrial networks, NTNs (such as satellites), optical switching networks, and the like. For example, the first flow includes one or more interim devices 150 along its path and the second flow includes one or more interim devices 160 along its path. A compound flow results in duplicate member flows at the duplication module 130. Data packets 170 originating from the duplication module 130 may arrive at the elimination module 130 via the first flow and/or second flow, and the duplicate member flow(s) result in a compound flow at the elimination module 140.

For the duplication module 130, a first copy of a data packet is deemed to belong to the first member flow and associated with the packet flow identification (ID) of the first flow. A second copy of the data packet is deemed belonging to the second flow and associated with the packet flow identification (ID) for the second flow. The flow identifications are distinct and different for each member flow that carries a copy of the data packet between the duplication and the elimination modules 130, 140. The packet flow identification may be explicit like an ID included in an MPLS label, Virtual Local Area Network (VLAN) tag, or other network communication technology, or the packet flow identification may be associated with a path like an ID included in a PRP, HSR, or other network communication protocol.

The duplicate packet elimination does not require any packet sequence numbers. Even so, a sequence number identical for the multiple duplicate packets may also be added into each duplicate packet to allow for compatibility with existing packet duplication systems. If the sequence numbers exist in the duplicate packets, then the system ignores them.

For the duplication module 130, the first duplicate packet of the first member flow is sent via the first path of the first member flow and the second duplicate packet of the second member flow is sent via the path of the second member flow. The member flows may cross diverse networks and use diverse services and diverse paths within those networks. The two member flows come together, and the duplicate is eliminated at the elimination module 140. The control application at the destination end device 120 does not receive the duplicate packets i.e., it receives only the compound flow.

Specific examples of the duplication and elimination modules 130, 140 implementations may be as follows, not excluding other examples. For one example, the packet duplication happens in DetNet service sublayer in a DetNet capable router, see RFC 8655. Each duplicate packet is further encapsulated into an MPLS packet as per IETF RFC 8964. The packet elimination happens in DetNet service sublayer in a DetNet capable router, see RFC 8655. For another example, the packet duplication and elimination happen, respectively, in an IEC 62439-3 PRP or HSR originating and receiving red boxes. Note that PRP as well as HSR are layer 2 technologies. Note that they may be used over IP networks and span large distances. This is often used over IP networks.

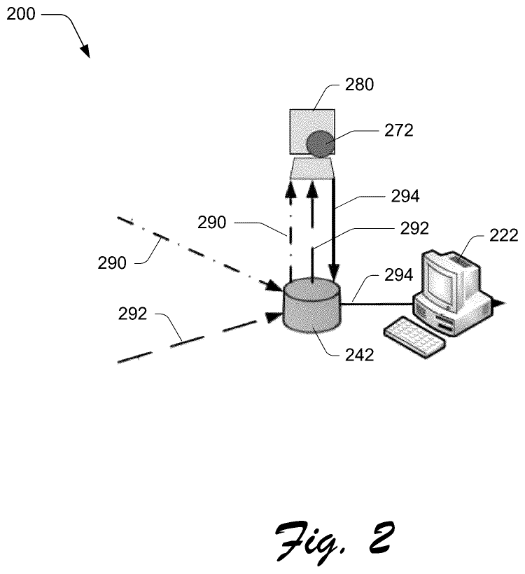

Referring to FIG. 2, there is shown a second system 200 operable, by example, to employ techniques described herein. Similar to the first system 100 illustrated by FIG. 1, the second system 200 includes a source end device forming multiple member flows, a duplication module forming duplicate packets to be carried by the duplicate flows, and one or more interim devices along each member flow. The components and manner for performing packet elimination and delivery to the destination end device 222 is different from the first system 100.

For the second system 200, the elimination module 280 is coupled to, and separate from, a routing module 242. The routing module 242 receives duplicate data packets via the member flows 290, 292 and delivers them to the elimination module 280 for processing. The elimination module 280, shown in FIG. 2, includes a control application to manage packet elimination, including the elimination of any duplicate packets so that only one copy 272 is delivered to the destination end device 222. From there, the data packet 272 of a single compound flow 294 is forwarded the destination end device 222.

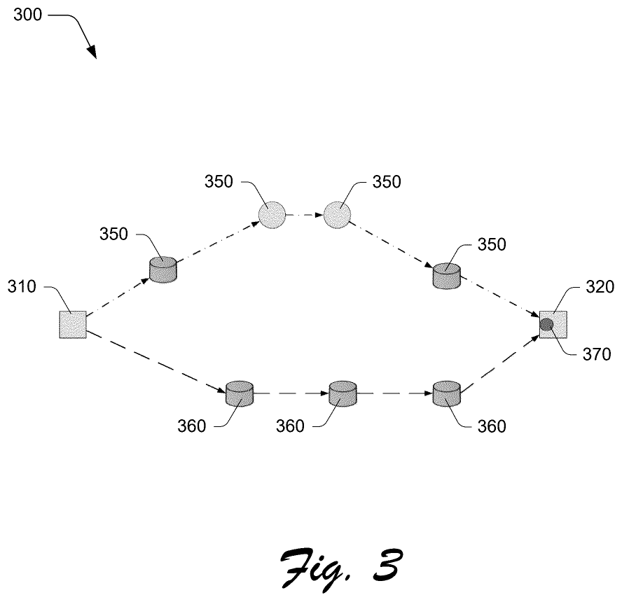

Referring to FIG. 3, there is shown a third system 300 operable, by example, to employ the techniques described herein. For the third system 300, message duplication occurs at an originating dual homed end device 310 and message elimination occurs at a receiving dual homed end device 320. The originating dual homed end device 310 includes the source end device and the duplication module, and the receiving dual homed end device 320 includes the destination end device and the elimination module. The originating dual homed end device 310 forms multiple member flows and duplicate packets to be carried by the duplicate flows. The third system 300 also includes one or more interim devices 350, 360 along each member flow. The receiving dual homed end device 320 eliminates any duplicate packets so that only one copy 370 is recognized at the end device 320.

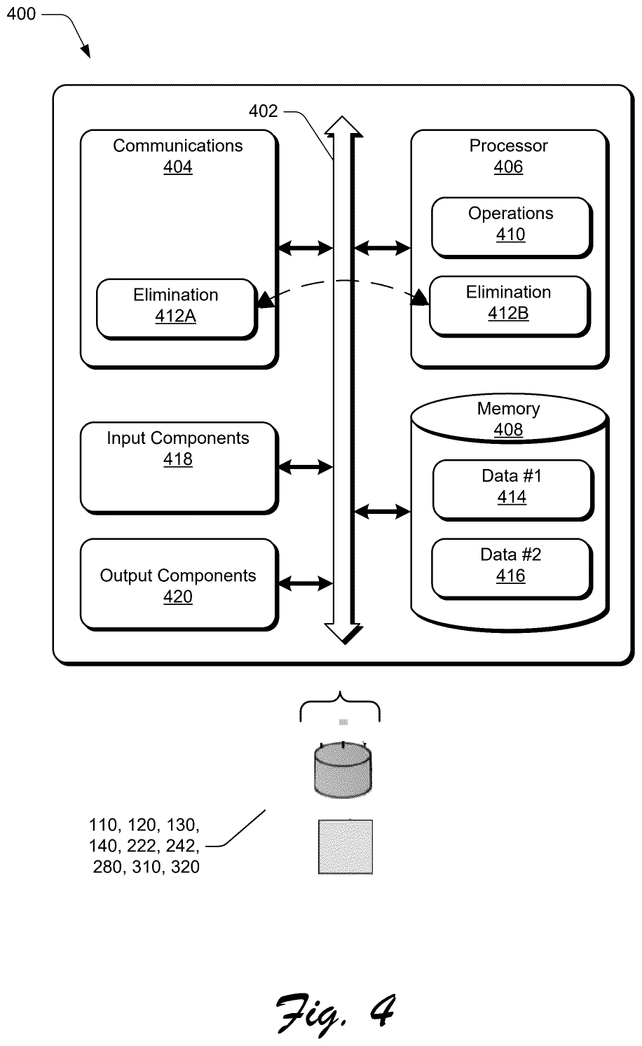

Referring to FIG. 4, there are shown system components of a system module 400 in an example implementation. Examples of the system device 400 include an end device 110, 120, 222, 310, 320, a duplication or elimination module 140, 280, 320, or other device/module 242. The system components comprise one or more communication lines 402 for interconnecting other system components directly or indirectly. The other system components include one or more communication components 404 communicating with other entities via a wired or wireless network, one or more processors 406, and one or more memory components 408. The communication component 404 communicates (i.e., receives and/or transmits) data associated with one or more devices of the system device 400 and its associated components. The communication component 404 may utilize wired or wireless technology for communication.

The processor or processors 406 may send data to, and process commands received from, other components of the system components, such as information of the communication component 404 or the memory component 408. Each application includes executable code to provide specific functionality for the processor 406 and/or remaining components of the system device 400.

Examples of applications executable by the communication component 404 and/or the processor 406 include, but are not limited to, an operations submodule 410 and an elimination submodule 412. The operations submodule 410 may be included in the processor 406 and performs general operations to manage the system device 400. The elimination submodule 412 may be included in the communications component 404 (as 412A), the processor 406 (as 412B), or both. The elimination submodule 412 may track the drop count and determine whether the drop count is greater than the threshold drop count. The elimination submodule 412 may also designate the second flow as the first flow, reassign the first flow, and set the drop count to the null value.

Data stored at the memory component 408 is information that may be referenced and/or manipulated by a module of the processor 406 for performing functions of the system device 400. Examples of data associated with the system device 400 and stored by the memory component 408 may include, but are not limited to, identification data 414 and drop count data 416. The identification data 414 stores a packet flow identification corresponding to each data packet including a first flow identification associated with the first flow and a second flow identification associated with the second flow. The drop count data 416 may store the drop count of the packet elimination module and the threshold drop count.

The system components may include input components 418 and output components 420 that manages one or more input components and/or an output component. The input components and the output components 418, 420 of the system components may also include one or more visual, audio, mechanical, or other components that receive and/or provide information with a user/operator of the system device 400.

It is to be understood that FIG. 4 is provided for illustrative purposes only to represent an example implementation of the system device 400 and is not intended to be a complete diagram of the various components that may be utilized by the device. The system device 400, may include various other components not shown in FIG. 4, may include a combination of two or more components, or a division of a particular component into two or more separate components, and still be within the scope of the present invention. Also, the components 400 may be coupled directly or indirectly to each other to perform the operations of the system device 400. For example, the processor 406 may be coupled, directly or indirectly, to the input/output component 418.

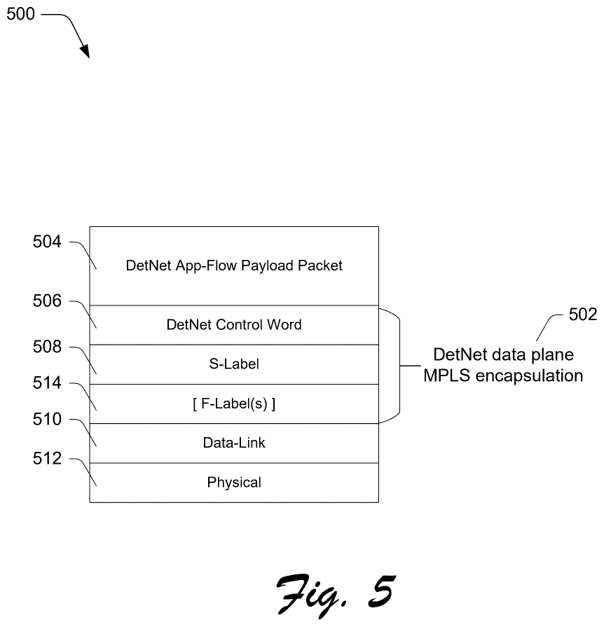

Referring to FIG. 5, there is shown represents an example encapsulation 500 for duplicate packets of the duplicate flows, see RFC 8964. For this example, the Deterministic Networking (DetNet) is an extension of the IP layer. A DetNet data plane 502 operates over a Multi-Protocol Label Switching (MPLS) packet switched network to implement the encapsulation. The example MPLS-based encapsulation 500 includes a payload packet data 504, control word data 506, S-label data 508, data-link data 510, and physical data 512. The MPLS-based encapsulation 500 may also include data 514 associated to one or more F-label(s). The control word data 506 and S-label data 508, as well as any F-label data 514 corresponds to the DetNet data plane 502 of the MPLS-based encapsulation 500. The control word (d-CW) data 506 includes sequence numbers that are needed for duplicate packet elimination. The S-label data 508 identifies a DetNet flow at the receiving DetNet service sub-layer processing node.

Packet Replication, Elimination, and Ordering functions (PREOF) at the DetNet data plane 502 identify tasks specific to the service sub-layer. If PREOF is configured, the same flow data will be sent over multiple outgoing DetNet member flows using forwarding sub-layer MPLS label switched paths. The S-Label data 508 is configured per outgoing member flow. The same control word data 506 is used on all outgoing member flows for each replicated MPLS packet. The duplicate elimination at the receiver is subject to specific implementations and may be combined with a jitter buffer e.g., ensuring almost no jitter, and with packet loss detection.

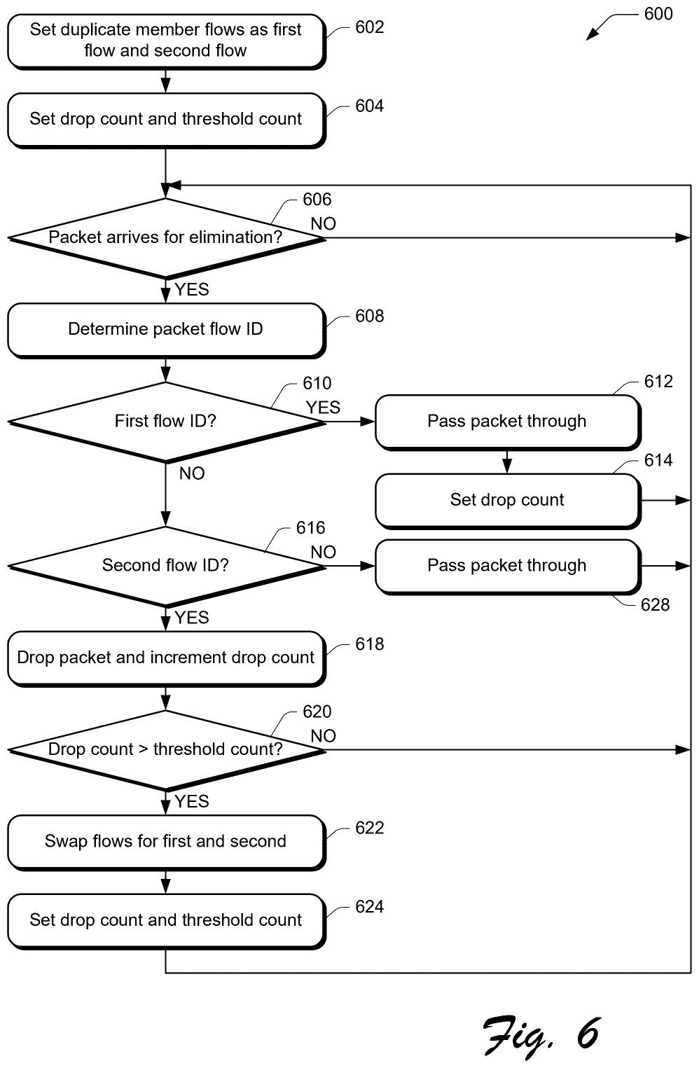

Referring to FIG. 6, there is shown a flow diagram of a first example operation 600 for processing duplicate packets by the packet elimination module. The duplicate packets. include a first flow and a second flow that may be dynamically swapped or changed during operation of the system. For some embodiments, the packet elimination module drops all packets of a currently designated second flow and no other packets. Passing other packets, in addition to a currently designated first flow, may be desired, such as, if the packet elimination module performs on a virtual interface that is intended to be dedicated to supporting the duplicate flows and other data like operation and maintenance of the flows including performance measurement data transfer.

The example operation 600 of the packet elimination system for resilience, as executed by the packet elimination module, establishes (602) duplicate member flows including a first flow and a second flow. Before processing the data packets, the initial values are configured at the packet elimination module. For example, one or more initial settings of the packet elimination module may be configured by the Network Management System (NMS) or by another entity. The packet elimination module includes a first flow identification and a second flow identification that are set or otherwise configured (602). For example, a first member flow is a first flow, and a second member flow is a second flow. For example, the first flow may have expected or measured delays that are less than the expected or measured delays of the second flow.

For some embodiments, the first flow may be selected based on Quality of Service (QOS) or business parameters, such as packet delays. These parameters may be expected values, actual values, or a combination of these values, such as their weighted sum. Examples of the parameters include, but are not limited to, packet delay variance, packet loss rate, preferred network provider, cost, and any the like. The QoS or business parameters may apply to a flow, path, node, or the like.

In general, the first flow identification and the second flow identification are selected dynamically. A drop count parameter (a.k.a., spare drop count parameter) includes the number of packets received on the second flow at the duplicate packet elimination module, after the currently last packet passes through the duplicate packet elimination module. If the duplicate packet elimination module received a packet quantity exceeding a threshold drop count (a.k.a., maximum spare drop count) from the second flow, then it sets the previously second flow as the first flow.

In response to setting (602) one duplicate member flow as the first flow and setting (602) another duplicate member flow as the second flow, the operation 600 sets (604) the drop count of the duplicate member flows to a null value, such as zero. For some embodiments, setting (604) the threshold drop count to a predetermined value greater than the null value. Also, the operation 600 sets (604) the threshold drop count to a determined value. For some embodiments, the threshold drop count may be changed during the packet elimination module operation. If the threshold drop count is set to a very high value, then only if there is a severe break in the packet delivery of the first flow, the previously second flow becomes the first flow. For example, the threshold drop count may be set to the approximate average number of packets that are expected to be transmitted in any 5 minutes interval of the duplicate flow. With 4000 packet/s, the threshold drop count may be set to 5 min*4000 packet/s=5 min*4000*60 packet/min=120,000 packets. The choice of the threshold drop count aids resilience of the packet delivery, by enabling delivery of the packets if there is a break in the service of the first flow.

Subsequent setting (604) the drop count and the threshold drop count, the operation 600 detects (606) a data packet at a packet elimination module of the packet elimination system. In response to detecting (606) the packet, the operation 600 determines (608, 610) whether the packet is associated with the first flow. For some embodiments, the operation 600 determines (608) a packet flow identification corresponding to the detected packet, i.e., a packet flow ID, and determine (610) whether the packet flow identification corresponding to the packet is equivalent to a first flow identification, i.e., first flow ID, associated with the first flow. The packet elimination module compares (610) the packet flow identification to the first flow identification, investigating whether these two identifications are logically identifying the same flow, for example, if these two identifications are mathematically identical. If yes, the packet belongs to the first flow. If no, then the packet does not belong to the first flow. The operation 600 passes (612) through the packet to the destination end device and sets (614) the drop count to the null value in response to determining (608, 610) that the packet is associated with the first flow.

The detected data packet may be dropped subsequent to determining that the packet is not associated with the first flow. For some embodiments, the detected data packet may be dropped in response, at least in part, to determining that the packet is not associated with the first flow. For example, the decision to drop may be based on the association with the first flow, the association with the second flow, or both. For some embodiments, the operation 600 may determine (616) whether the packet is associated with the second flow in response to determining (608, 610) that the detected packet is not associated with the first flow. For these embodiments, the packet is dropped (618) and the drop count is incremented (618) in response to determining (616) that the packet is associated with the second flow. The packet elimination module compares (616) the packet flow identification to the second flow identification, investigating if these two identifications are logically identifying the same flow, for example, if these two identifications are mathematically identical. If yes, then the packet belongs to the second flow. If no, then the packet does not belong to the second flow and, in addition, the operation 600 of the packet elimination module passes (628) the packet through to wait for the next data packet to arrive (606) since the packet does not belong to the first flow nor to the second flow.

In response to dropping (618) the detected data packet and/or incrementing (618) the drop count, the operation 600 determines (620) whether the drop count is greater than the threshold drop count. It is to be understood that this is equivalent to determining whether the drop count meets the threshold drop count so long as the threshold drop count is greater than the null value by more than a single count. If the drop count does not meet this criteria (e.g., exceed the threshold drop count), then the operation 600 will continue with waiting for the next data packet to arrive (606).

In response to determining (620) that the drop count is greater than a threshold drop count or an equivalent comparison, the first operation 600 changes (622) the flows, and updates (624) the counts. The operation 600 of the elimination module changes (622) the flows as a result of multiple instances exceeding the threshold (i.e., not just a single instance) of determining (616, 610) that the packet is associated with the second flow and not associated with the first flow in the interim. The operation 600 designates (620) the second flow as the first flow and reassigns (622) the first flow. In situations where there are only two member flows, the first and second flows are effectively swapped. In other words, the previously second flow becomes the first flow and the previously first flow becomes the second flow. Also, the operation 600 sets (624) the drop count to the null value. In addition to setting (624) the drop count to the null value, the operation 600 may set (624) the threshold drop count. For some embodiments, the drop count is set (624) in response to designating (622) the second flow and reassigning the first flow.

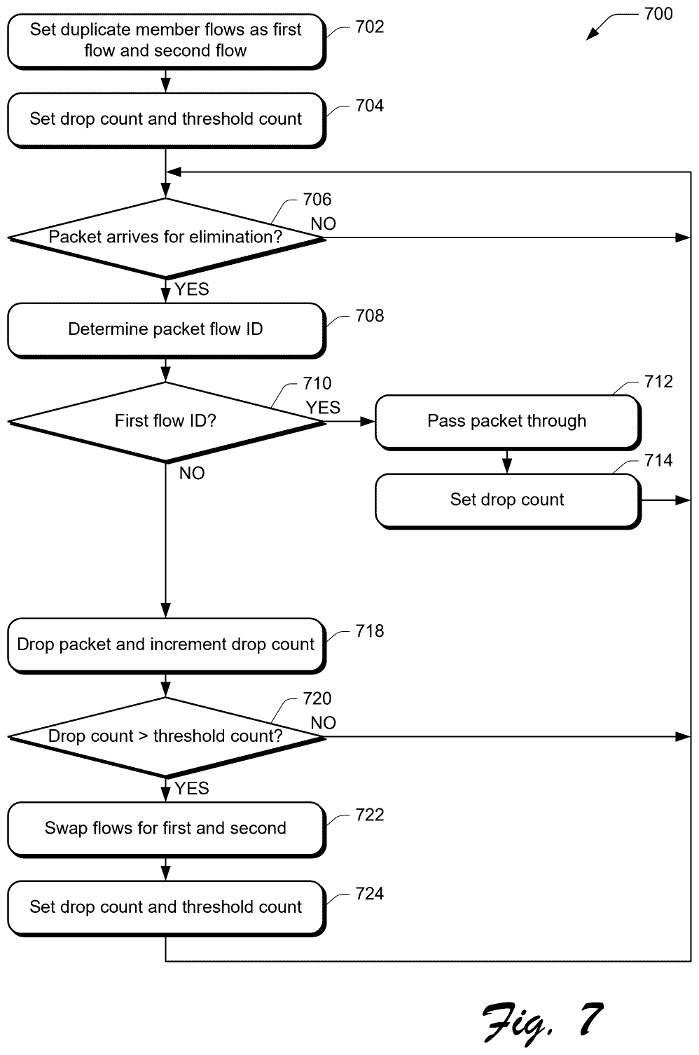

Referring to FIG. 7, there is shown a flow diagram of a second example operation 700 for processing duplicate packets by the packet elimination module. The second operation 700 is similar to the first example operation 600 but does not include any determination of whether a detected data packet is associated with the second flow. By this variant, the packet elimination module drops all packets that do not belong to the first flow. This variant may be useful, for example, if the module performs on a virtual interface that is intended to be dedicated to supporting the duplicate flows only.

The second operation 700 sets (702, 704) one duplicate member flow as the first flow, sets another duplicate member flow as the second flow, and the drop count to a null value. For some embodiments, the second operation 700 sets (704) the threshold drop count to a predetermined value greater than the null value. Also, the second operation 700 sets (704) the threshold drop count to a determined value. The second operation 700 detects (706) a data packet at a packet elimination module of the packet elimination system and determines (708, 710) whether the packet is associated with the first flow. For some embodiments, the second operation 700 determines (708) a packet flow identification corresponding to the detected packet and determine (710) whether the packet flow identification corresponding to the packet is equivalent to a first flow identification associated with the first flow. The second operation 700 passes (712) through the packet to the destination end device and sets (714) the drop count to the null value in response to determining (708, 710) that the packet is associated with the first flow. The detected data packet is dropped and the drop count is incremented subsequent to, and in response to, determining that the packet is not associated with the first flow.

In response to dropping (718) the detected data packet and/or incrementing (718) the drop count, the second operation 700 determines (720) whether the drop count is greater than the threshold drop count. Again, it is to be understood that this is equivalent to determining whether the drop count meets the threshold drop count so long as the threshold drop count is greater than the null value by more than one count. If the drop count does not meet this criteria (e.g., exceed the threshold drop count), then the second operation 700 will continue with waiting for the next data packet to arrive (706).

In response to determining (720) that the drop count is greater than a threshold drop count or an equivalent comparison, the second operation 700 changes (722) the flows, and updates (724) the counts. The second operation 700 of the elimination module changes (722) the flows as a result of multiple consecutive instances exceeding the threshold (i.e., not just a single instance) of determining (710) that the packet is not associated with the first flow. The second operation 700 designates (720) the second flow as the first flow and reassigns (722) the first flow. The second operation 700 sets (724) the drop count to the null value. In addition to setting (724) the drop count to the null value, the second operation 700 may set (724) the threshold drop count. For some embodiments, the drop count is set (724) in response to designating (722) the second flow and reassigning the first flow.

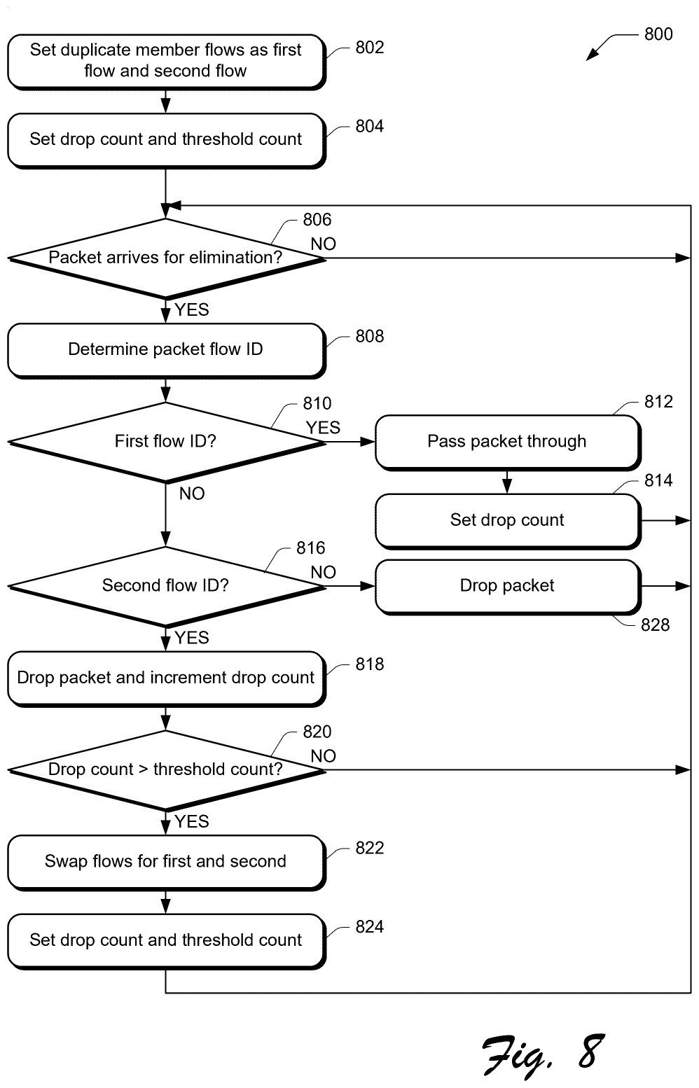

Referring to FIG. 8, there is shown a flow diagram of a third example operation 800 for processing duplicate packets by the packet elimination module. The third operation 800 is similar to the first example operation 600 but the detected data packet is dropped in response to determining that the packet is not associated with the second flow. By this variant, the packet elimination module drops all packets that do not belong to the first flow. This variant may be useful, for example, if the module performs on a virtual interface that is intended to be dedicated to supporting the duplicate flows only, and no protocol control frames.

The third operation 800 sets (802, 804) one duplicate member flow as the first flow, sets another duplicate member flow as the second flow, and the drop count to a null value. For some embodiments, the third operation 800 sets (804) the threshold drop count to a predetermined value greater than the null value. Also, the third operation 800 sets (804) the threshold drop count to a determined value. The third operation 800 detects (806) a data packet at a packet elimination module of the packet elimination system and determines (808, 810) whether the packet is associated with the first flow. For some embodiments, the third operation 800 determines (808) a packet flow identification corresponding to the detected packet and determine (810) whether the packet flow identification corresponding to the packet is equivalent to a first flow identification associated with the first flow. The third operation 800 passes (812) through the packet to the destination end device and sets (814) the drop count to the null value in response to determining (808, 810) that the packet is associated with the first flow. If the packet is not associated with the first flow (808, 810), then the third operation 800 determines (816) whether the packet is associated with the second flow.

The detected data packet may be dropped subsequent to determining that the packet is not associated with the first flow. For some embodiments, the detected data packet may be dropped in response, at least in part, to determining that the packet is not associated with the first flow. In particular, the detected data packet is dropped (818, 828) in response to determining whether the packet is or is not associated with the second flow. In addition, the third operation 800 increments (818) the drop count.

In response to determining (816) that the packet is associated with the second flow or its operation thereafter (818), the third operation 800 determines (820) whether the drop count is greater than the threshold drop count. Again, it is to be understood that this is equivalent to determining whether the drop count meets the threshold drop count so long as the threshold drop count is greater than the null value by more than one count. If the drop count does not meet this criteria (e.g., exceed the threshold drop count), then the third operation 800 will continue with waiting for the next data packet to arrive (806).

In response to determining (820) that the drop count is greater than a threshold drop count or an equivalent comparison, the third operation 800 changes (822) the flows, and updates (824) the counts. The third operation 800 of the elimination module changes (822) the flows as a result of multiple instances exceeding the threshold (i.e., not just a single instance) of determining (816, 810) that the packet is associated with the second flow and not associated with the first flow in the interim. The third operation 800 designates (820) the second flow as the first flow and reassigns (822) the first flow. The third operation 800 sets (824) the drop count to the null value. In addition to setting (824) the drop count to the null value, the third operation 800 may set (824) the threshold drop count. For some embodiments, the drop count is set (824) in response to designating (822) the second flow and reassigning the first flow.

The end device may be configured to forward the packets to two packet duplication modules and two packet elimination modules for resilience may be deployed. Packet duplication and elimination modules may further be nested in diverse ways. In addition, the duplicate packet elimination module for resilience may be implemented concomitantly with the existing duplicate packet elimination modules for reliability in routers, switches, red boxes, etc., so that the same packet duplication methods may be used. The network management system may configure use of each module per flow or per interface or similar.

Those skilled in the art will recognize that, for simplicity and clarity, the full structure and operation of all data processing systems suitable for use with the present disclosure are not being depicted or described herein. Also, none of the various features or processes described herein should be considered essential to any or all embodiments, except as described herein. Various features may be omitted or duplicated in various embodiments. Various processes described may be omitted, repeated, performed sequentially, concurrently, or in a different order. Various features and processes described herein can be combined in still other embodiments as may be described in the claims.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include nonvolatile, hard-coded type mediums such as read only memories (ROMs) or erasable, electrically programmable read only memories (EEPROMs), and user-recordable type mediums such as memory sticks, flash drives, and hard disk drives.

Although an example embodiment of the present disclosure has been described in detail, those skilled in the art will understand that various changes, substitutions, variations, and improvements disclosed herein may be made without departing from the spirit and scope of the disclosure in its broadest form.

1. A packet elimination system for resilience comprising:
a plurality of duplicate member flows including a first flow and a second flow, the plurality of duplicate member flows including a drop count set to a null value; and
a packet elimination module of the packet elimination system to detect a packet, the packet elimination module passing the packet through to a destination end device and setting the drop count to the null value in response to determining that the packet is associated with the first flow, the packet elimination module dropping the packet and incrementing the drop count subsequent to determining that the packet is not associated with the first flow;
wherein the packet elimination module designates the second flow as the first flow, reassigns the first flow, and sets the drop count to the null value in response to determining that the drop count is greater than a threshold drop count.

2. The packet elimination system as described in claim 1, wherein the plurality of duplicate member flows include a threshold drop count set to a predetermined value greater than the null value.

3. The packet elimination system as described in claim 1, wherein the packet elimination module determines that a packet flow identification corresponding to the packet is not equivalent to a first flow identification associated with the first flow.

4. The packet elimination system as described in claim 1, wherein the packet elimination module drops the packet and increments the drop count in response to determining that the packet is not associated with the first flow.

5. The packet elimination system as described in claim 1, wherein the packet elimination module determines whether the packet is associated with the second flow.

6. The packet elimination system as described in claim 5, wherein the packet elimination module drops the packet and increments the drop count in response to determining that the packet is associated with the second flow.

7. The packet elimination system as described in claim 1, wherein the packet elimination module sets the drop count in response to designating the second flow and reassigning the first flow.

8. A method of a packet elimination system for resilience, the method comprising:
establishing a plurality of duplicate member flows including a first flow and a second flow;
setting a drop count of the plurality of duplicate member flows to a null value;
detecting a packet at a packet elimination module of the packet elimination system;
passing through the packet to a destination end device and setting the drop count to the null value in response to determining that the packet is associated with the first flow;
dropping the packet and incrementing the drop count subsequent to determining that the packet is not associated with the first flow;
designating the second flow as the first flow, reassigning the first flow, and setting the drop count to the null value in response to determining that the drop count is greater than a threshold drop count.

9. The method as described in claim 8, further comprising setting the threshold drop count to a predetermined value greater than the null value.

10. The method as described in claim 8, wherein determining that the packet is not associated with the first flow includes determining that a packet flow identification corresponding to the packet is not equivalent to a first flow identification associated with the first flow.

11. The method as described in claim 8, wherein dropping the packet and incrementing the drop count includes dropping the packet and incrementing the drop count in response to determining that the packet is not associated with the first flow.

12. The method as described in claim 8, further comprising determining whether the packet is associated with the second flow.

13. The method as described in claim 12, wherein dropping the packet and incrementing the drop count includes dropping the packet and incrementing the drop count in response to determining that the packet is associated with the second flow.

14. The method as described in claim 8, wherein designating the second flow, reassigning the first flow, and setting the drop count includes setting the drop count in response to designating the second flow and reassigning the first flow.

15. A non-transitory computer readable medium including executable instructions which, when executed, causes at least one processor to provide resilience for a packet elimination system by:
establishing a plurality of duplicate member flows including a first flow and a second flow;
setting a drop count of the plurality of duplicate member flows to a null value;
detecting a packet at a packet elimination module of the packet elimination system;
passing through the packet to a destination end device and setting the drop count to the null value in response to determining that the packet is associated with the first flow;
dropping the packet and incrementing the drop count subsequent to determining that the packet is not associated with the first flow;
designating the second flow as the first flow, reassigning the first flow, and setting the drop count to the null value in response to determining that the drop count is greater than a threshold drop count.

16. The medium as described in claim 15, further comprising setting the threshold drop count to a predetermined value greater than the null value.

17. The medium as described in claim 15, wherein determining that the packet is not associated with the first flow includes determining that a packet flow identification corresponding to the packet is not equivalent to a first flow identification associated with the first flow.

18. The medium as described in claim 15, wherein dropping the packet and incrementing the drop count includes dropping the packet and incrementing the drop count in response to determining that the packet is not associated with the first flow.

19. The medium as described in claim 15, further comprising determining whether the packet is associated with the second flow, wherein dropping the packet and incrementing the drop count includes dropping the packet and incrementing the drop count in response to determining that the packet is associated with the second flow.

20. The medium as described in claim 15, wherein designating the second flow, reassigning the first flow, and setting the drop count includes setting the drop count in response to designating the second flow and reassigning the first flow.
